(19) United States
(12) Patent Application Publication
(10) Pub. No.: US 2011/0038759 A1
(43) Pub. Date: Feb. 17, 2011

(54) DEVICE FOR ORGANIC MATERIAL DECOMPOSITION

(76) Inventor: Pin-Nan Lai, Caotun Township (TW)

Correspondence Address: Wang Law Firm, Inc., 4989 Peachtree Parkway,, Suite 200, Norcross, GA, 30092, US

(21) Appl. No.: 12/541,138

(22) Filed: Aug. 13, 2009

(51) Int. Cl. G05D 16/00

(52) U.S. Cl. 422/112

(57) ABSTRACT

A device for organic material decomposition is disclosed. An organic material to be processed is disposed in a closed container. It is heated and stirred at the same time to speed up the decomposition of organic materials. This prevents the generation of waste water and malodor. The organic material decomposition device is fixed on a movable carrier. The movable carrier is provided with a protection unit on both sides of its long axial direction for protecting the organic material decomposition device as the carrier moves.

### BACKGROUND OF THE INVENTION

1. Field of Invention

The invention relates to an organic material decomposition device and, in particular, to a device that rapidly decomposes an organic material disposed in a closed container thereof. The device has the feature of mobility.

2. Related Art

In most of the methods for processing organic wastes, yeasts are often added into and stirred with the wastes. The yeasts then naturally decompose the organic wastes, turning them into organic fertilizers (e.g., the composting method).

The advantage of this method is that it involves a simple process. However, it is likely to generate waste water and malodor. The natural decomposition time varies with organic materials and may take as long as one or two months. Moreover, it has the problem of incomplete fermentation.

To speed up the decomposition of organic wastes using the yeasts, a common method is to dispose the organic wastes and yeast powders in a heated container, in which heating and stirring are performed simultaneously. This in principle can speed up the organic waste decomposition and thorough fermentation.

Nevertheless, the above-mentioned method inevitably produces more fermentation gas with a malodor, causing another problem to the public.

After long-time researches, the inventor has discovered a method to avoid the problems in the prior art. The organic wastes are disposed in a closed container to speed up the decomposition. The organic material decomposition device according to the invention does not produce waste water and malodor.

Besides, most organic wastes are processed in the suburb areas, they have to be shipped. One has to be very careful during the shipping process in order to avoid any leakage to pollute the environment. Therefore, it is another feature of the invention to improve the mobility of the organic material decomposition device, so that the organic material will not pollute the environment during the shipping process.

### SUMMARY OF THE INVENTION

An objective of the invention is to provide an organic material decomposition device for the above-mentioned problems. According to the invention, organic materials to be processed are disposed in a closed container. The lid of the container is provided with a pressure-limiting valve, which is connected to a burning heater via a pipeline. When a gas is produced inside the container and reaches a predetermined pressure, a pressure controller is turned on to send a signal to a fan. The gas is then guided into the burning heater for burning. The burnt gas is then released to the atmosphere to avoid the production of malodor gas. During the high-temperature heating and stirring process, waste water generated during the decomposition process is effectively vaporized. Therefore, essentially no waste water is produced.

Another objective of the invention is to provide an organic material decomposition device that has a good sealing property and can be fixed on a movable carrier. Each side of the carrier is provided with a protection unit. This prevents the organic materials from polluting the environment during the shipping process.

In accord with the above-mentioned objectives, the invention is an organic material decomposition device that includes a container. The container has a closed lid, a stirring device therein driven by a power source, a dumping gate at the bottom, and a circulating fuel tank around its walls. The circulating fuel tank connects to a burning heater. The burning heater connects to both the circulating fuel tank and a fuel barrel via a fuel pipe, respectively. The circulating fuel is used to indirectly heat up materials inside the container. The lid has a filling gate and a pressure-limiting valve. The pressure-limiting valve connects to the burning heater via a pipeline. When the gas produced inside the container reaches a predetermined pressure, the pressure controller is turned on to send out a signal to the fan, guiding the gas into the burning heater for burning.

When the organic material decomposition device has to be moved, it is disposed on a movable carrier. The protection unit provided on both sides of the long axial direction of the carrier protects the organic material decomposition device as the carrier moves.

### BRIEF DESCRIPTION OF THE DRAWINGS

The invention will become more fully understood from the detailed description given herein below illustration only, and thus is not limitative of the present invention, and wherein:

FIG. 1 is a schematic view showing the configuration of the disclosed organic material decomposition device;

FIG. 2 is a schematic view of the structure in the first embodiment of the invention;

FIG. 3 is another schematic view of the structure in the first embodiment of the invention;

FIG. 4 is yet another schematic view of the structure in the first embodiment of the invention;

FIG. 5 is a schematic view of the structure in the second embodiment of the invention; and

FIG. 6 is another schematic view of the structure in the second embodiment of the invention.

### DETAILED DESCRIPTION OF THE INVENTION

The present invention will be apparent from the following detailed description, which proceeds with reference to the accompanying drawings, wherein the same references relate to the same elements.

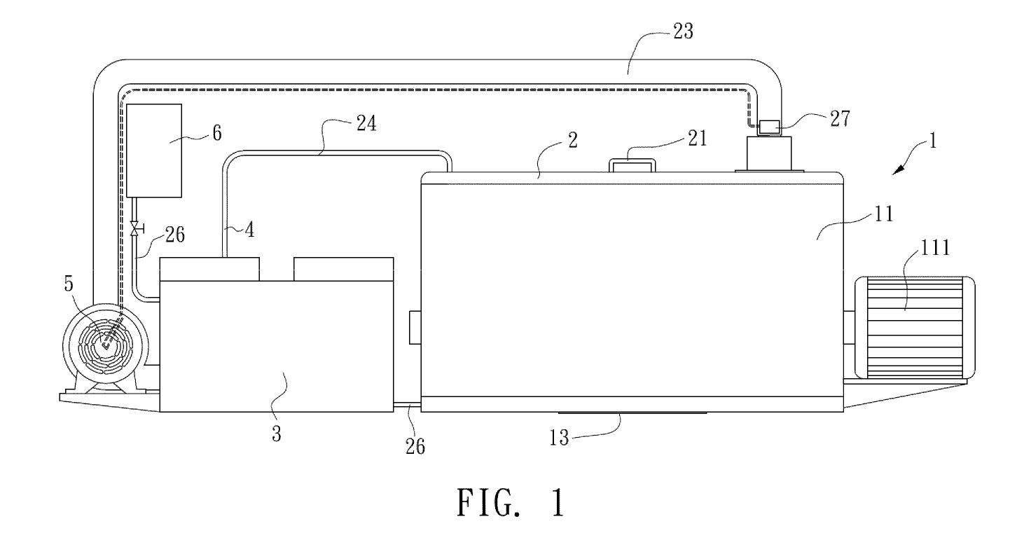

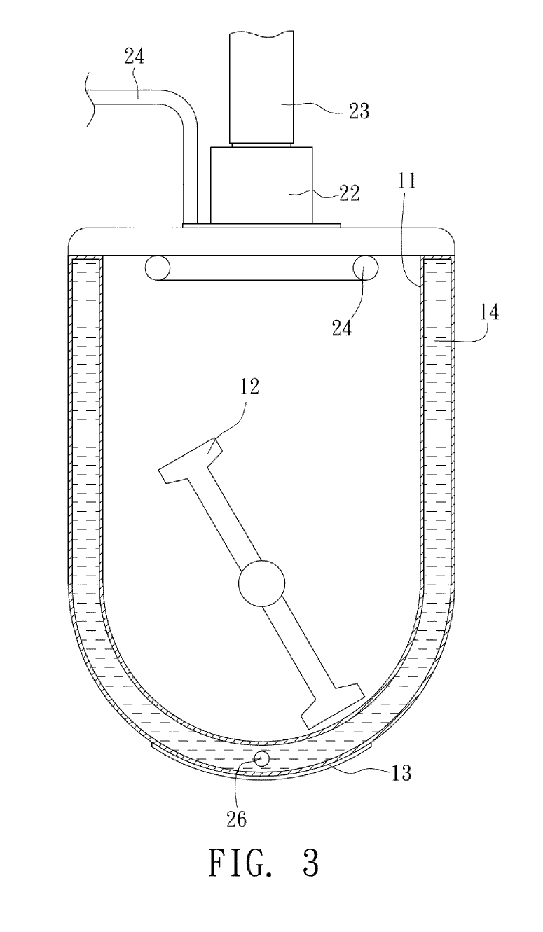

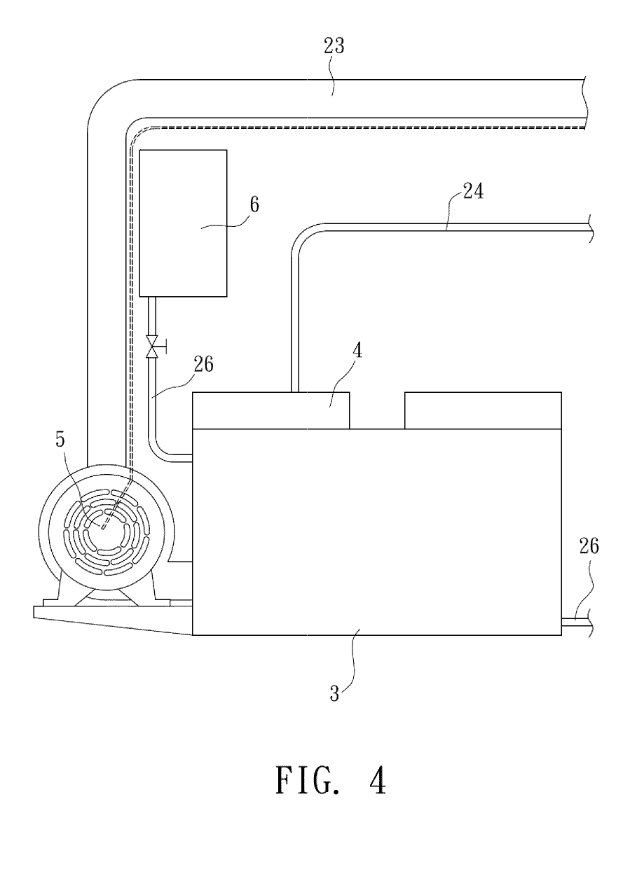

Please refer to FIGS. 1 to 6 for embodiments of the invention. These embodiments are for the purpose of explanation only and should not be construed to limit the scope of the invention.

As shown in FIG. 1, the disclosed organic material decomposition device 1 includes a container 11. The container 11 has a closed lid 2, a set of stirring device 12 inside driven by a power source 111, a dumping gate 13 at the bottom, and a circulating fuel tank 14 around its walls. The circulating fuel tank 14 connects to a burning heater 3. The burning heater 3 connects to both the circulating fuel tank 14 and a fuel barrel 6 via a fuel pipe 26, respectively. The circulating fuel is used to indirectly heat up materials inside the container 11.

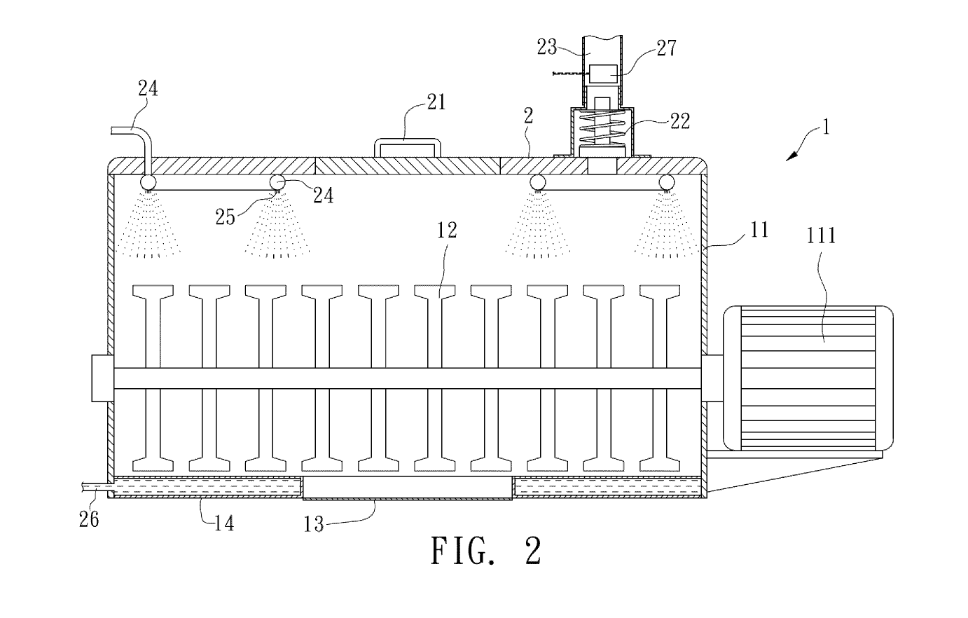

As shown in FIGS. 2 to 4, the lid 2 has a filling gate 21 and a pressure-limiting valve 22. The pressure-limiting valve 22 connects to the burning heater 3 via a pipeline 23. When the gas produced inside the container 11 reaches a predetermined pressure, a pressure controller 27 is turned on to send out a signal to a fan 5, guiding the gas into the burning heater 3 for burning.

The inner surface of the lid 2 is provided with a vapor pipeline 24 with several release holes 25. The vapor pipeline 24 connects to a vapor generator 4 heated by the burning heater 3. Therefore, the produced vapor travels through the vapor pipeline 24 to adjust the moisture and remove malodor of the contents inside the container 11 via the release holes 25.

Besides, the waste water produced during the decomposition process of the organic materials inside the container 11 is vaporized during the heating and stirring processes. Along with the produced gas, it is guided into the burning heater 3 via the pressure-limiting valve 22 on the lid 2 and the pipeline 23 for burning. The burnt gas is then released to the atmosphere. This avoids the production of waste water and malodor.

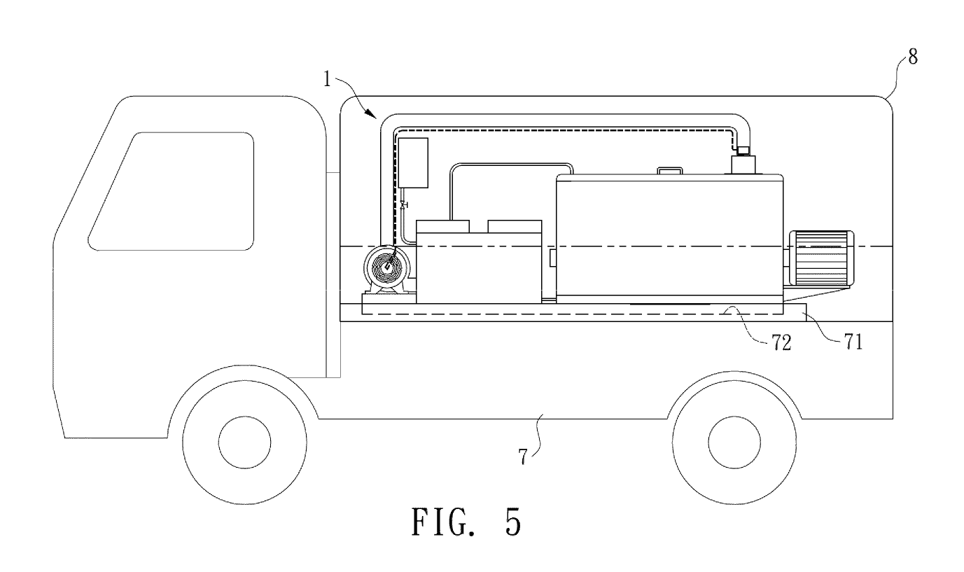

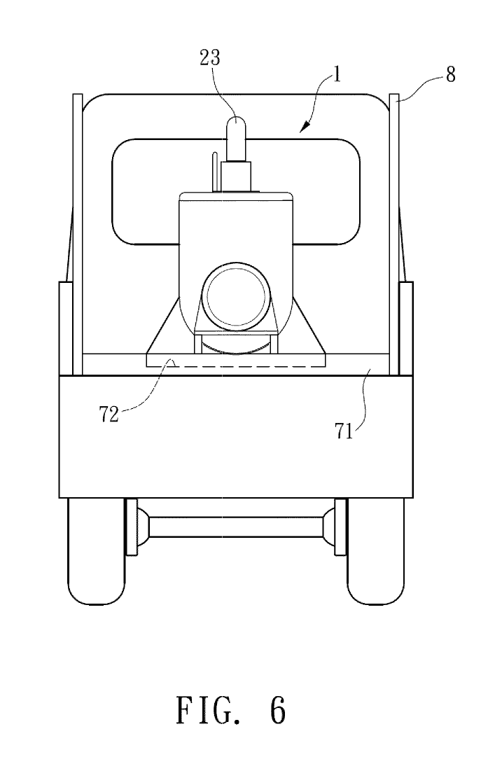

FIGS. 5 and 6 show a second embodiment of the invention. The invention in this embodiment includes an organic material decomposition device 1, a movable carrier 7, and a protection unit 8. The carrier 7 is a truck in this embodiment. Moreover, the carrier 7 has a fixed base 71 with an accommodation space 72 for accommodating the organic material decomposition device 1. The protection unit 8 is provided along the long axial direction of the carrier 7. In this embodiment, the protection unit 8 has two walls with an appropriate height for protecting the safety of the organic material decomposition device 1 when the carrier 7 moves.

Therefore, the invention has the feature of high mobility and good enclosing property. The problem of environmental pollution during the shipping process can thus be prevented.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An organic material decomposition device, comprising:
a container, which has a closed lid, a set of stirring device inside driven by a power source, a dumping gate at the bottom, and a circulating fuel tank around its walls, the circulating fuel tank connecting to a burning heater;
wherein the burning heater connects to the circulating fuel tank and a fuel barrel via a fuel pipeline, respectively; the circulating fuel is used to indirectly heat up materials inside the container; the lid has a filling gate and a pressure-limiting valve, the pressure-limiting valve connecting to the burning heater via a pipeline; when the gas produced inside the container reaches a predetermined pressure, the pressure controller is turned on to send out a signal to the fan, guiding the gas into the burning heater for burning; and the inner surface of the lid is provided with a vapor pipeline with a plurality of release holes and connecting to a vapor generator heated by the burning heater, so that produced vapor adjusts moisture and remove malodor of the contents inside the container via the release holes.

2. The organic material decomposition device of claim 1 disposed in an accommodation space in the base of a movable carrier for arbitrarily moving the organic material decomposition device.

3. The organic material decomposition device of claim 2, wherein a protection unit is provided on the base along its long axial direction and the protection unit has two walls of appropriate height for protecting the organic material decomposition device as the carrier moves.
